(19) United States
(12) Patent Application Publication
(10) Pub. No.: US 2009/0040343 A1
(43) Pub. Date: Feb. 12, 2009

(54) METHODS AND APPARATUSES FOR DEFECTIVE PIXEL DETECTION AND CORRECTION

(75) Inventor: Chang-Jung Kao, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/834,086

(22) Filed: Aug. 6, 2007

(51) Int. Cl. H04N 9/64

(52) U.S. Cl. 348/246

(57) ABSTRACT

An apparatus for defective pixel detection and correction is provided. The apparatus comprises a defective pixel detection unit and a defective pixel correction unit. The defective pixel detection unit acquires a detection pixel and a plurality of neighboring pixels, and determines that the detection pixel is a defective pixel when a first condition and a second condition are satisfied, wherein the defective pixel is located in the center of a n×n block comprising the detection and neighboring pixels, the first condition describes that at most one neighboring pixel whose value differs from the value of the detection pixel within a predefined threshold is detected, and the second condition describes that all the neighboring pixels other than the detected neighboring pixel is smaller or larger than the value of the detection pixel. The defective pixel correction unit corrects a value of the defective pixel determined by the defective pixel detection unit.

### BACKGROUND OF THE INVENTION

1. Field of the Invention

The invention relates to image processing, and more precisely, to methods and apparatuses for determining and correcting defective pixels in an image.

2. Description of the Related Art

Image sensors have found widespread use in camera systems. One of the more important specifications of an image sensor is the cosmetic quality. A sensor's image should be ideally flawless. However, due to processing imperfections, statistical deviations, etc., a finite number of pixels in a sensor array will be defective or yield a signal that deviates visibly from the exact pixel value.

It is therefore desired to provide methods and apparatuses for determining and correcting defective pixels in an image.

### BRIEF SUMMARY OF THE INVENTION

An embodiment of the invention provides an apparatus for defective pixel detection and correction. The apparatus comprises a defective pixel detection unit and a defective pixel correction unit. The defective pixel detection unit acquires a detection pixel and a plurality of neighboring pixels, and determines that the detection pixel is a defective pixel when a first condition and a second condition are satisfied, wherein the defective pixel is located in the center of a n×n block comprising the detection and neighboring pixels, the first condition describes that at most one neighboring pixel whose value differs from the value of the detection pixel within a predefined threshold is detected, and the second condition describes that all the neighboring pixels other than the detected neighboring pixel is smaller or larger than the value of the detection pixel. The defective pixel correction unit corrects a value of the defective pixel determined by the defective pixel detection unit.

An embodiment of the invention also provides a method for defective pixel detection and correction. The method comprises the following steps. A detection pixel and a plurality of neighboring pixels are first acquired, wherein the defective pixel is located in the center of a n×n block comprising the detection and neighboring pixels. The detection pixel is determined to be a defective pixel when a first condition and a second condition are satisfied, wherein the first condition describes that at most one neighboring pixel whose value differs from the value of the detection pixel within a predefined threshold is detected, and the second condition describes that all the neighboring pixels other than the detected neighboring pixel is smaller or larger than the value of the detection pixel. Then, a value of the defective pixel determined by the defective pixel detection unit is corrected.

### BRIEF DESCRIPTION OF THE DRAWINGS

The invention can be more fully understood by reading the subsequent detailed description and examples with reference to the accompanying drawings, wherein:

FIG. 1 schematically shows a process of an image signal processor (ISP);

FIG. 2A shows an exemplary 5×5 array of a Bayer pattern image;

FIGS. 2B-2D are diagrams illustrating sampling windows of exemplary 5×5 arrays of a Bayer pattern image;

FIG. 3 shows an embodiment of a defective pixel detection and correction unit according to the invention;

FIG. 4 is a flowchart of an embodiment of a method for defective pixel detection according to the invention;

FIGS. 5A and 5B illustrate exemplary data distribution of pixel values satisfying the first condition and the second condition according to the invention;

FIG. 6A is a flowchart of an embodiment of a method for determining whether a third condition is satisfied according to the invention;

FIGS. 6B-6C illustrate neighboring pixels of exemplary 5×5 arrays for determining whether a third condition is satisfied according to the invention;

FIG. 6D is a flowchart of an embodiment of a method for determining whether a third condition is satisfied according to the invention;

FIG. 7A is a flowchart of an embodiment of a method for determining whether a fourth condition is satisfied according to the invention;

FIG. 7B illustrates neighboring pixels of an exemplary 5×5 sample array for determining whether a fourth condition is satisfied according to the invention;

FIG. 8 is a flowchart of an embodiment of a method for defective pixel detection and correction for a G pixel according to the invention;

FIG. 9 is a flowchart of an embodiment of a method for defective pixel detection and correction for a G pixel according to the invention;

FIG. 10 is a flowchart of an embodiment of a method for defective pixel detection and correction for a G pixel according to the invention;

FIG. 11 is a flowchart of an embodiment of a method for defective pixel detection and correction for a G pixel according to the invention;

FIG. 12 is a flowchart of an embodiment of a method for defective pixel detection and correction for a R or B pixel according to the invention; and

FIG. 13 is a flowchart of an embodiment of a method for defective pixel detection and correction for a R or B pixel according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

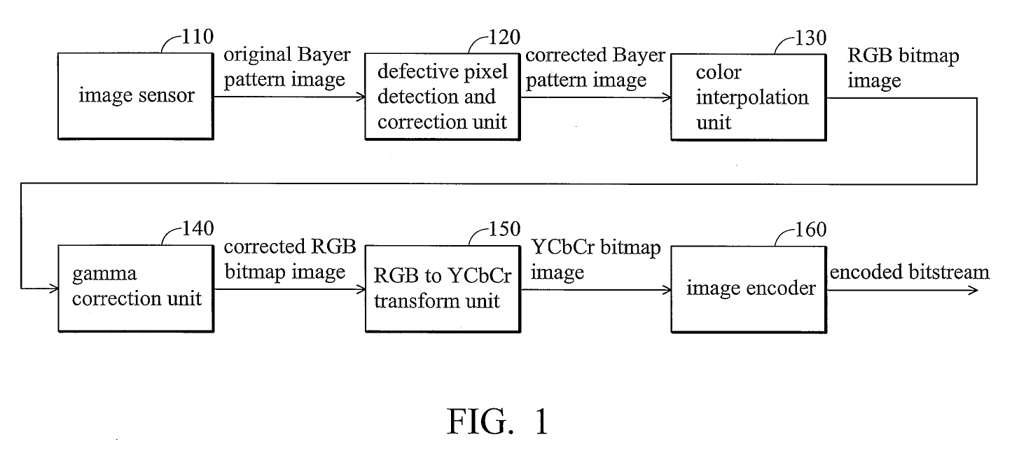

The invention is now described with reference to FIGS. 1 through 13, which generally relate to defective pixel detection and correction. In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the invention. The following detailed description is, therefore, not to be taken in a limiting sense. It should be understood that many of the elements described and illustrated throughout the specification are functional in nature and may be embodied in one or more physical entities or may take other forms beyond those described or depicted.

The embodiments of the invention provide methods and apparatuses for defective pixel detection and correction so as to detect more than one defective pixel within a sample n×n Bayer pattern image. In one embodiment, an apparatus for defective pixel detection and correction is provided. The apparatus comprises a defective pixel detection unit and a defective pixel correction unit. The defective pixel detection unit acquires a detection pixel and a plurality of neighboring pixels, and determines that the detection pixel is a defective pixel when a first condition and a second condition are satisfied, wherein the defective pixel is located in the center of a n×n block comprising the detection and neighboring pixels, the first condition describes that at most one neighboring pixel whose value differs from the value of the detection pixel within a predefined threshold is detected, and the second condition describes that all the neighboring pixels other than the detected neighboring pixel is smaller or larger than the value of the detection pixel. The defective pixel correction unit corrects a value of the defective pixel determined by the defective pixel detection unit.

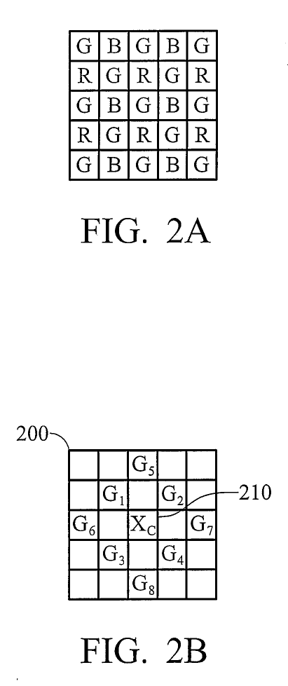

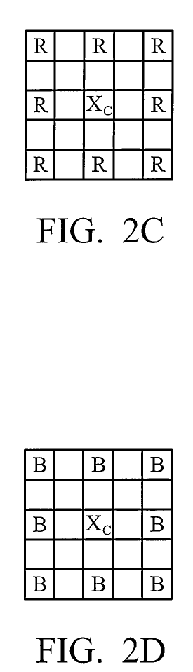

FIG. 1 schematically shows a process of an image signal processor (ISP). An image sensor 110 generates an original Bayer pattern image based on the detected input image. Contrary to a RGB image which each pixel stores three color values of red (R), green (G) and blue (B), each pixel of a Bayer pattern contains information that is relative to only one color component, such as G, B or R. FIG. 2A shows an exemplary 5×5 Bayer pattern image. As shown in FIG. 2A, there are G/B rows that alternate green G and blue pixels B, and R/G rows that alternate red R and green G pixels. Therefore, a Bayer pattern image is substantially a mosaic of red, green and blue pixels, where there are twice as many green pixels as red or blue pixels. This array can accurately represent an image because the human eye is more sensitive to the green data than either the red or blue.

As usually practiced in image filtering processes, the image array is scanned in a top-down manner starting from the top leftmost pixel. Depending on the color of the pixels to be processed, the appropriate selection window (rectangular or diamond shaped) having the pixel to be processed as a center pixel is chosen. Two selection windows are considered: a diamond shaped mask for green (G) pixels as shown in FIG. 2B, and a rectangular mask for red (R) and blue (B) pixels as shown in FIGS. 2C and 2D, respectively.

For example, a set of nine pixels of the same color of a Bayer image is selected as a selection window, one of which is located at the center of the window and will be referred to as a detection pixel which is the pixel to be examined, while the remaining eight pixels will be referred to as neighboring pixels. For example, as shown in FIG. 2B, pixel Xc is the detection pixel and pixels G1-G8 are neighboring pixels of the pixel Xc if the pixel Xc is a G pixel. It is to be understood that the selection window may contain more or less than nine pixels of the same color of a Bayer image.

A defective pixel detection and correction unit 120 then receives the original Bayer pattern image, determines defective pixels within the original Bayer pattern image and generates a corrected Bayer pattern image by correcting the detected defective pixels. The color interpolation unit 130 interpolates the corrected Bayer pattern image generated by the defective pixel detection and correction unit 120 to get a complete color image, RGB bitmap image. Each pixel of the resulting RGB bitmap image contains information that is relative to three color components, such as G, B and R. The RGB bitmap image is further processed by a gamma correction unit 140 to perform a gamma correction process therewith and to generate a corrected RGB bitmap image, which further been transformed into a YCbCr bitmap image by the RGB to YCbCr transform unit 150. The YCbCr bitmap image is then encoded into an encoded bitstream (e.g. JPEG, MPEG bitstream) by the image encoder 160 and may be displayed on a display unit (not shown), such as LCD.

According to an embodiment of the present invention, all the defective pixels in the original Bayer pattern image can be detected and corrected so as to generate a corrected Bayer pattern image with higher accuracy for the subsequent color interpolation unit 130.

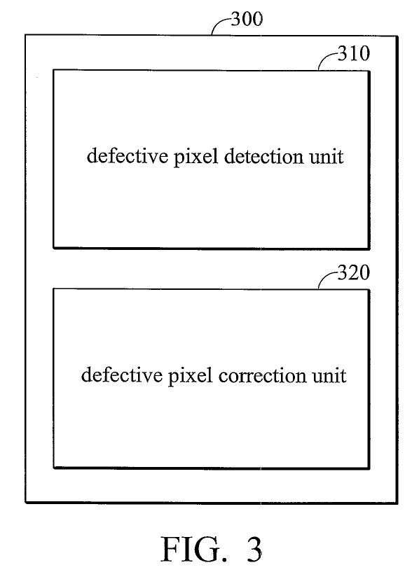

FIG. 3 shows an embodiment of a defective pixel detection and correction unit 300 for detecting and correcting the defective pixel according to the invention. The defective pixel detection and correction unit 300 comprises a defective pixel detection unit 310 and a defective pixel correction unit 320. Several conditions to be described in the following can be employed by the defective pixel detection unit 310 to determine whether the detection pixel is a defective pixel. The defective pixel detection unit 310 acquires a n×n block pixel array comprising a detection pixel and a plurality of neighboring pixels, and determines that the detection pixel is a defective pixel when specific conditions are satisfied. The defective pixel correction unit 320 then corrects a value of the defective pixel determined by the defective pixel detection unit 310. The detection pixel is located in the center of a n×n block comprising the detection and neighboring pixels. Please refer to FIG. 2B, for example, the pixel 210 (Xc) located in the center of the 5×5 block (pixel array) 200 is the detection pixel while pixels G1-G8 are the neighboring pixels. A first condition describes that at most one neighboring pixel whose value differs from the value of the detection pixel within a predefined threshold is detected, and a second condition describes that all the neighboring pixels other than the detected neighboring pixel is smaller or larger than the value of the detection pixel.

In the following description of different embodiments of the invention for the first and second conditions, reference will be made to a set of nine green (G) pixels from a 5×5 Bayer pattern image, though the same considerations also apply for a rectangular selection window for selecting red (R) or blue (B) pixels.

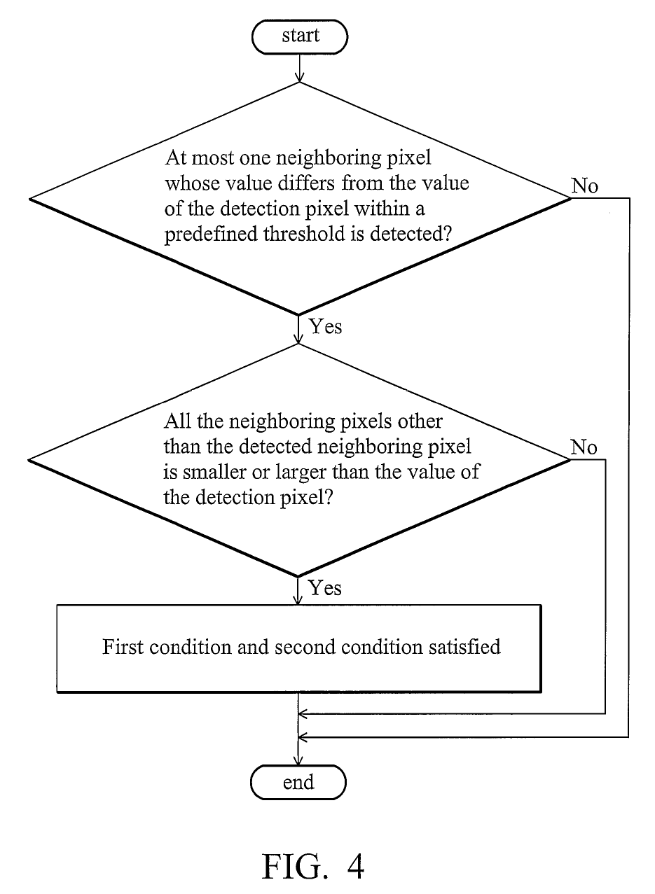

FIG. 4 is a flowchart of an embodiment of a method for defective pixel detection according to the invention. As shown, a detection pixel is referred to as a defective pixel by determining whether a first condition and a second condition are satisfied. The first condition describes that at most one neighboring pixel whose value differs from the value of the detection pixel within a predefined threshold is detected, and the second condition describes that all the neighboring pixels other than the detected neighboring pixel is smaller or larger than the value of the detection pixel.

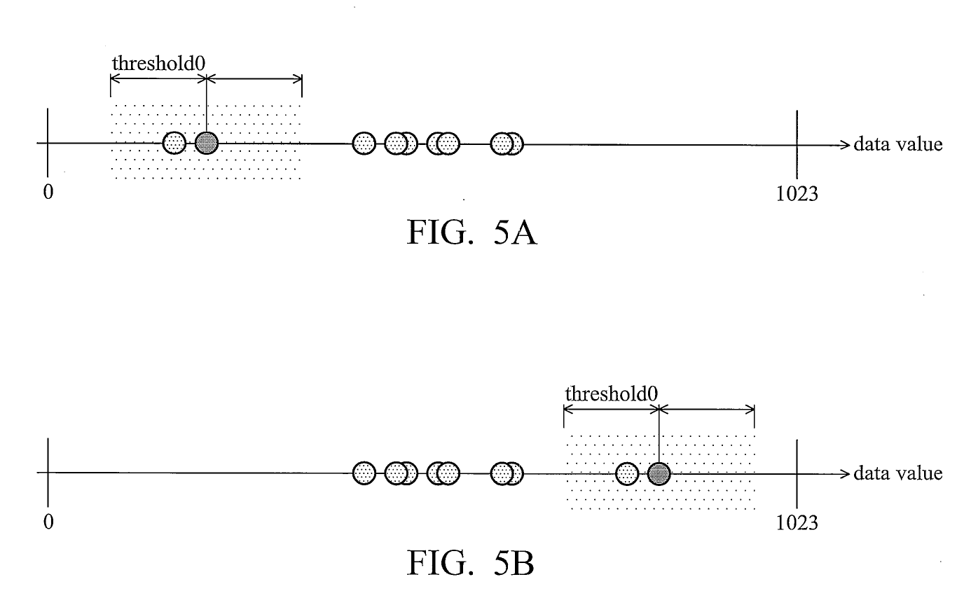

FIGS. 5A and 5B are schematic diagrams illustrating data distribution of pixel values that satisfy the first condition and the second condition according to the invention. It is assumed that a pixel value is a value ranging from 0 to 1023 and eight neighboring pixels are depicted as brighter circles, while the detection pixel is depicted as a darker circle. It is to be understood that the neighboring pixels have the same color as that of the detection pixel. For example, the colors of neighboring pixels selected are green if the color of the detection pixel is green, while the colors of neighboring pixels selected are red or blue if that of the detection pixel is red or blue, respectively. As shown in FIGS. 5A and 5B, pixels (including the detection pixel and the neighboring pixels) are aligned according to their pixel values. Referring to FIGS. 5A and 5B, the following observations hold. When Xc satisfies the first and second conditions, at most one neighboring pixel whose value differs from the value of the detection pixel within a predefined threshold is detected, and all the neighboring pixels other than the detected neighboring pixel is smaller (FIG. 5B) or larger (FIG. 5A) than the value of the detection pixel.

It is observed that at most one pixel value differs from the value of the detection pixel within a predefined threshold is detected and all neighboring pixels other than the detected neighboring pixel outside the area are located on one side of the detection pixel, such as left-hand or right-hand side. Specifically, referring to FIG. 5A, all the pixel values of the neighboring pixels are larger than the detection pixel value Xc plus the predefined threshold. Referring to FIG. 5B, all the pixel values of the neighboring pixels are smaller than the detection pixel value Xc minus the predefined threshold. Note that the predefined threshold may be fixed, or may be adjusted by users to meet various applications.

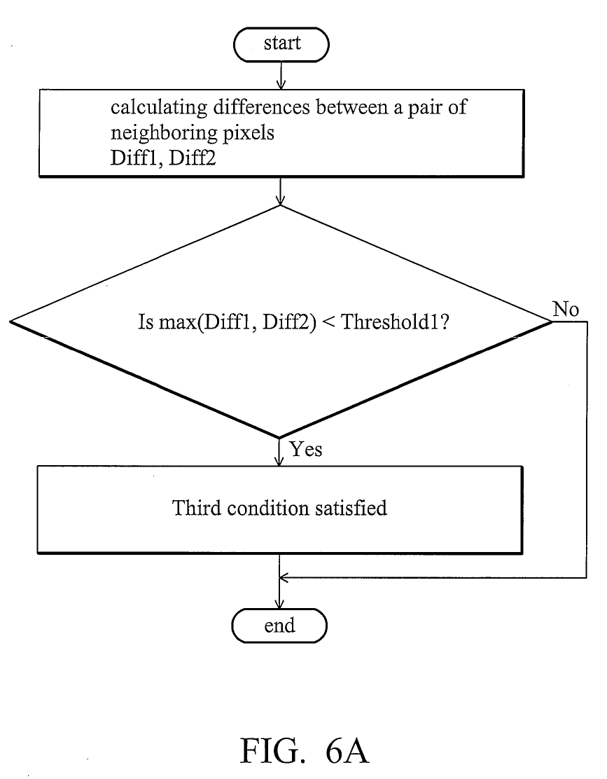

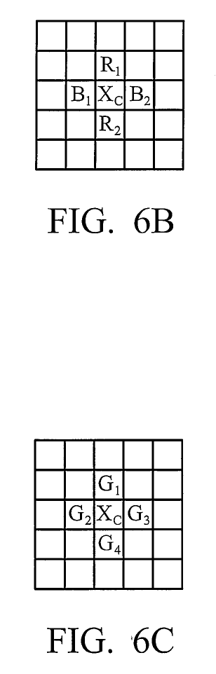

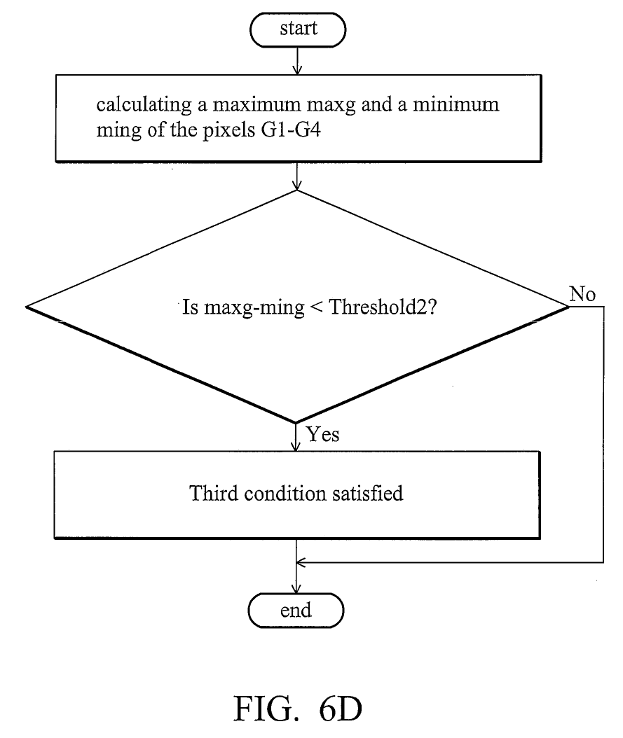

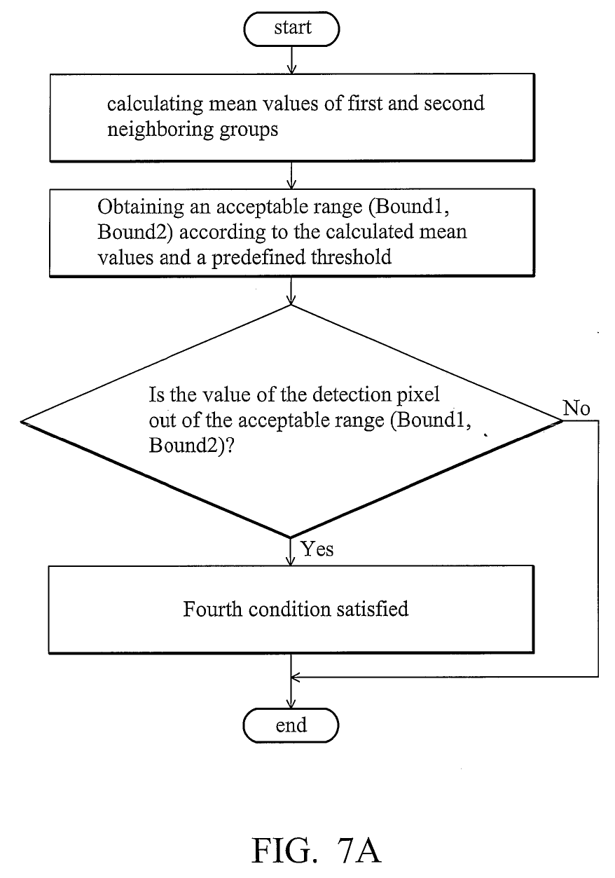

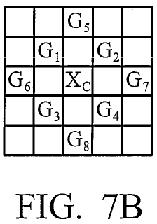

In addition to the first and second conditions, essential conditions, a third condition and/or a fourth condition are introduced to filter out unimportant or misjudged pixels. Details of the third condition and fourth condition will be described as follows with reference to FIGS. 6A-6D and 7A-7B, respectively.

FIG. 6A is a flowchart illustrating an embodiment of a method for determining whether the third condition is satisfied for a G pixel according to the invention. In this example, four pixels surrounding to the detection pixel Xc, with colors other than that of Xc, are used for determining whether the detection pixel Xc is located in a smooth area or a complex area. For example, referring to FIG. 6B, pixels R1, R2, B1 and B2 are selected to be analyzed for the detection pixel Xc when the detection pixel Xc is a G pixel. Referring to FIG. 6C, pixels G1, G2, G3 and G4 are selected to be analyzed for the detection pixel Xc when the detection pixel Xc is a R pixel or B pixel. That the detection pixel Xc locates in a smooth area is determined when the values of these four neighboring pixels are similar to each other, otherwise, it is determined that the detection pixel Xc locates in a complex area. If so, the detection pixel Xc originally determined as a defective pixel candidate is determined as a defective pixel and could be corrected. The detection pixel Xc locating on a complex area can be ignored because such bias of the detection pixel Xc is difficult to be observed.

For the detection pixel Xc as a G pixel, referring to FIG. 6A and FIG. 6B, the differences between pairs of neighboring pixels are calculated by following formulae:

Diff1=abs(R1−R2);

Diff2=abs(B1−B2),

where abs(R1−R2) is an absolute value of the difference between R1 and R2, and abs(B1−B2) is an absolute value of the difference between B1 and B2.

If the maximum of the calculated differences Diff1 and Diff2 is less than a predefined threshold Threshold1, the third condition is satisfied.

Similarly, for the detection pixel Xc as a R or B pixel, referring to FIG. 6D and FIG. 6C, four neighboring pixels are G pixels, such as G1-G4 shown in FIG. 6C. FIG. 6D is a flowchart of another embodiment of a method for determining whether the third condition is satisfied for an R or B pixel according to the invention.

The maximum and the minimum of the pixels G1-G4 are calculated by following formulae:

ming=min(G1,G2,G3,G4);

maxg=max(G1,G2,G3,G4),

where min(G1,G2,G3,G4) is the minimum value of pixels G1-G4 and max(G1,G2,G3,G4) is the maximum value of pixels G1-G4. If the difference between maxg and ming is less than a predefined threshold Threshold2, the third condition is satisfied.

FIG. 7A is a flowchart of an embodiment of a method for determining whether the fourth condition is satisfied according to the invention. Note that the fourth condition is used for G pixels only. In this example, the fourth condition utilizes eight neighboring pixels, for each G pixel, for defective pixel detection. In an embodiment, the eight neighboring pixels are divided into two neighboring groups, each having four pixels. Four of the eight neighboring pixels, with shorter distance from the detection pixel Xc, are grouped into a first neighboring group, and the other neighboring pixels with longer distance from the detection pixel Xc are grouped into a second neighboring group. For example, referring to FIG. 7B, the pixels G1 to G8 are selected as neighboring pixels of the detection pixel Xc, wherein pixels G1, G2, G3 and G4 with shorter distance from the detection pixel Xc are grouped into a first neighboring group, and pixels G5, G6, G7 and G8 with longer distance from the detection pixel Xc, are grouped into a second neighboring group. Then, mean values of pixel values for the first and second neighboring groups are calculated respectively, and are then used to obtain a boundary of an acceptable range for the detection pixel Xc, e.g. an upper bound and a lower bound. If the value of the detection pixel Xc is out of the estimated boundary, the detection pixel Xc satisfies the fourth condition. Referring to FIG. 7A and FIG. 7B, a mean value of pixel values (G1-G4) of the first neighboring group, denoted Mean1, and a mean value of pixel values (G5-G8) of the second neighboring group, denoted Mean2, are calculated by the following formulae:

Mean1=(G1+G2+G3+G4−min(G1,G2,G3,G4)−max(G1,G2,G3,G4))/2;

Mean2=(G5+G6+G7+G8−min(G5,G6,G7,G8)−max(G5,G6,G7,G8))/2,

where min(G1,G2,G3,G4) represents the minimum value of pixel values G1-G4 and max(G1,G2,G3,G4) represents the maximum value of pixel values G1-G4.

Then, the difference Diff between Mean1 and Mean2 is determined. An upper boundary Bound1 and a lower boundary Bound2 are later determined by following formulae:

Diff=Mean1−Mean2;

Bound1=Mean1+Diff*Threshold3;

Bound2=Mean1−Diff*Threshold3,

where Threshold3 is a predefined threshold value.

Then, the upper boundary Bound1 and lower boundary Bound2 are used to generate an acceptable range (Bound2, Bound1). If the value of the detection pixel Xc is out of the range between Bound1 and Bound2, the fourth condition is satisfied; otherwise, the fourth condition is not satisfied.

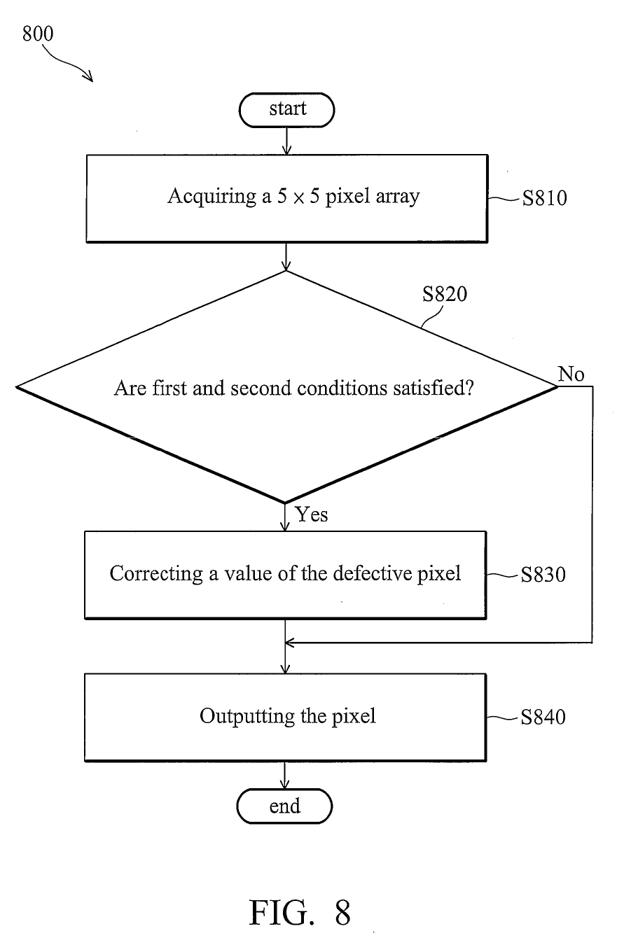

FIGS. 8-13 are flowcharts illustrating various embodiments of methods for defective pixel detection and correction employing the described conditions.

FIG. 8 is a flowchart of an embodiment of a method for defective pixel detection and correction for a G pixel according to the invention.

Referring to both FIG. 3 and FIG. 8, a 5×5 pixel array, as shown in FIG. 2A, is first acquired by the defective pixel detection unit 310 (step S810). Subsequently, it is determined whether the first condition and second condition are satisfied (step S820). In step S820, steps illustrated in FIG. 4 are performed. If so, the detection pixel is identified as a defective pixel and a defective pixel correction process is performed to the detection pixel by the defective pixel correction unit 320 (step S830). Then the corrected pixel is output to the color interpolation unit for further processing (step S840). If any of the first condition and second condition is not satisfied (No in step S810), the detection pixel is identified as a non-defective pixel and its value is directly output to the color interpolation unit without correction (step S840).

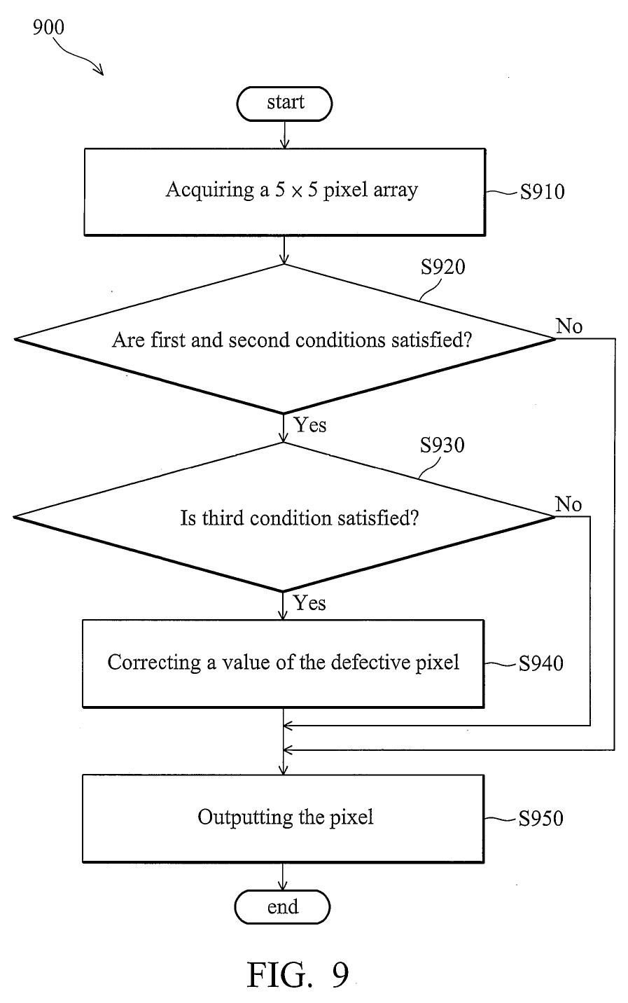

FIG. 9 is a flowchart of an embodiment of a method for defective pixel detection and correction for a G pixel according to the invention.

As shown, a 5×5 pixel array, as shown in FIG. 2A is first acquired (step S910). Subsequently, it is determined whether the first condition and second condition are satisfied (step S920). The operations of steps S910 and S920 are similar with those of steps S810 and S820 of FIG. 8, and are only briefly described herein. In step S920, the steps illustrated in FIG. 4 are performed. If any of the first condition and second condition is not satisfied (No in step S920), the detection pixel is identified as a non-defective pixel and its value is directly output to the color interpolation unit without correction (step S950). After passing the inspection of the first condition and second condition, it is determined whether the third condition is satisfied (step S930). In step S930, steps illustrated in FIG. 6A are performed and, referring to the FIG. 6B, pixels R1, R2, B1 and B2 are selected as neighboring pixels of the detection pixel Xc. If so, the detection pixel is identified as a defective pixel and a defective pixel correction process is performed to the detection pixel (step S940). Then the corrected pixel is output to the color interpolation unit for further processing (step S950). If the third condition is not satisfied (No in step S930), the detection pixel is identified as a non-defective pixel and its value is directly output to the color interpolation unit without correction (step S950).

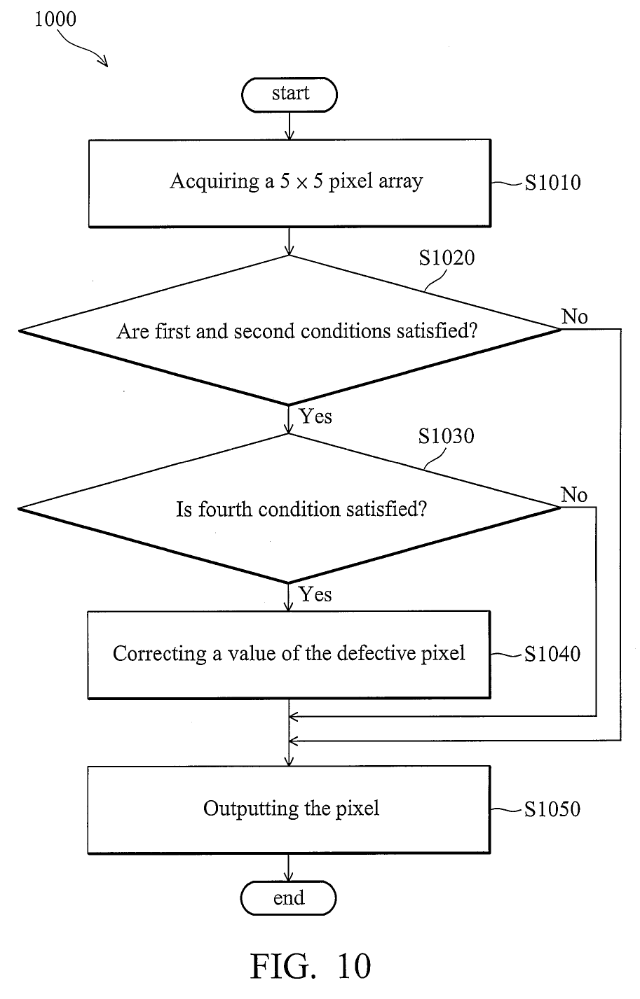

FIG. 10 is a flowchart illustrating an embodiment of a method for defective pixel detection and correction for a G pixel according to the invention.

As shown, a 5×5 pixel array, as shown in FIG. 2A, is first acquired (step S1010). Subsequently, it is determined whether the first condition and second condition are satisfied (step S1020). The operations of steps S1010 and S1020 are similar with those of steps S810 and S820 of FIG. 8, and are only briefly described herein. In step S1020, the steps illustrated in FIG. 4 are performed. If any of the first condition and second condition are not satisfied (No in step S1020), the detection pixel is identified as a non-defective pixel and its value is directly output to the color interpolation unit without correcting (step S1050). After passing the inspection of the first condition and second condition, it is determined whether the fourth condition is satisfied (step S1030). In step S1030, steps illustrated in FIG. 7A are performed and selected neighboring pixels G1-G8 as shown in FIG. 7B. If so, the detection pixel is identified as a defective pixel and a defective pixel correction process is performed to the detection pixel (step S1040). Then the corrected pixel is output to the color interpolation unit for further processing (step S1050). If the fourth condition is not satisfied (No in step S1030), the detection pixel is identified as a non-defective pixel and its value is directly output to the color interpolation unit without correction (step S1050).

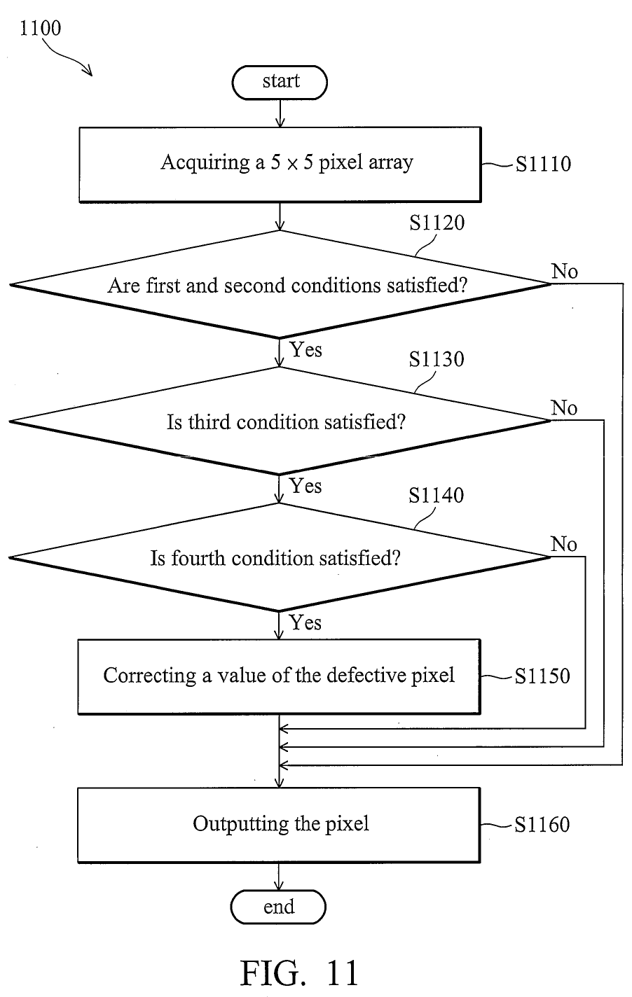

FIG. 11 is a flowchart illustrating an embodiment of a method for defective pixel detection and correction for a G pixel according to the invention. As shown, some steps of FIG. 11 are similar with those of FIG. 9, and are only briefly described herein, except that a further step for determining whether the fourth condition is satisfied is added as a further constraint to check whether the detection pixel is a defective pixel or not. It is observed that only the detection pixel satisfying all conditions is identified as a defective pixel, otherwise the detection pixel is identified as a non-defective pixel.

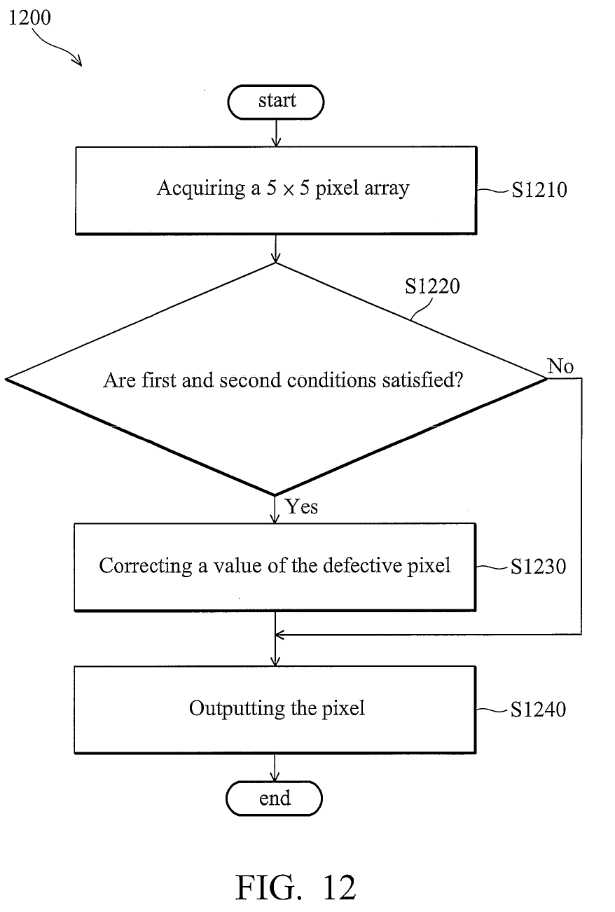

FIG. 12 is a flowchart illustrating an embodiment of a method for defective pixel detection and correction for an R pixel or B pixel according to the invention.

A 5×5 pixel array, as shown in FIG. 2A, is first acquired (step S1210). The neighboring pixels are selected as shown in FIG. 2C or FIG. 2D depending on which color of the detection pixel. Subsequently, it is determined whether the first condition and second condition are satisfied (step S1220). In step S1220, steps illustrated in FIG. 4 are performed. If so, the detection pixel determined by the defective pixel detection unit 310 is identified as a defective pixel and a defective pixel correction process is performed to the detection pixel (step S1230). Then the corrected pixel is output to the color interpolation unit for further processing (step S1240). If any of the first condition and second condition is not satisfied (No in step S1220), the detection pixel is identified as a non-defective pixel and its value is directly output to the color interpolation unit without correction (step S1040).

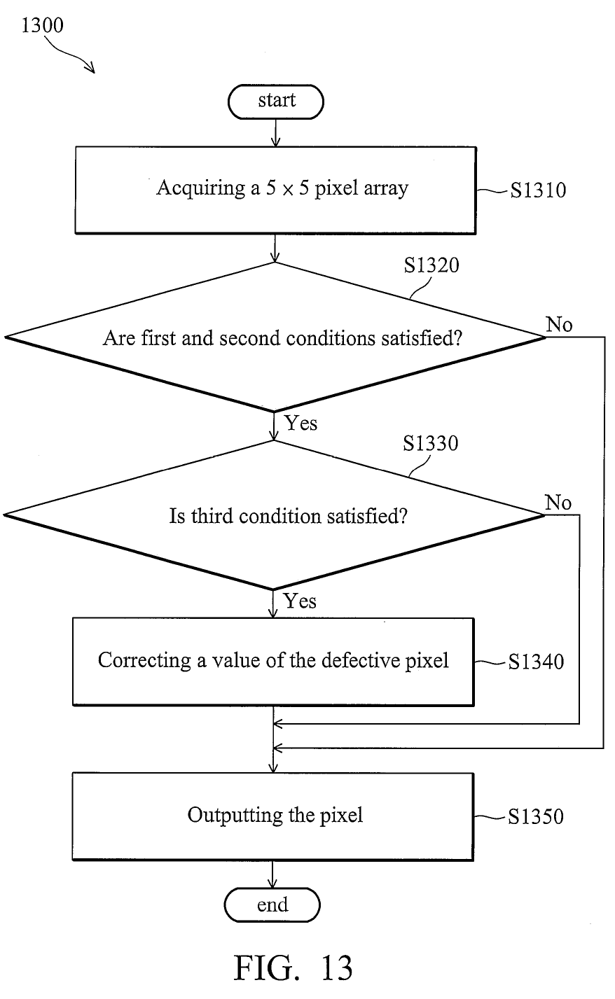

FIG. 13 is a flowchart illustrating an embodiment of a method for defective pixel detection and correction for an R pixel or B pixel according to the invention.

As shown, a 5×5 pixel array is first acquired (step S1310). Subsequently, it is determined whether the first condition and second condition are satisfied (step S1320). The operations of steps S1310 and S1320 are similar with those of steps S1210 and S1220 of FIG. 12. In step S1320, the steps illustrated in FIG. 4 are performed. If any of the first condition and second condition is not satisfied (No in step S1320), the detection pixel is identified as a non-defective pixel and its value is directly outputs to the color interpolation unit without correcting (step S1350). After passing the inspection of the first condition and second condition, it is determined whether the third condition is satisfied (step S1330). In step S1220, steps illustrated in FIG. 6D are performed and, referring to FIG. 6C, pixels G1, G2, G3 and G4 are selected as neighboring pixels of the detection pixel Xc. If so, the detection pixel is identified as a defective pixel and a defective pixel correction process is performed to the detection pixel (step S1340). Then the corrected pixel is output to the color interpolation unit for further processing (step S1350). If the third condition is not satisfied (No in step S1330), the detection pixel is identified as a non-defective pixel and its value is directly outputs to the color interpolation unit without correction (step S1350).

The described embodiments for defective pixel detection and correction, or certain aspects or portions thereof, may be practiced in logic circuits, or may take the form of program codes (i.e., instructions) embodied in tangible media, such as floppy diskettes, CD-ROMS, hard drives, or any other machine-readable storage medium, wherein, when the program codes are loaded into and executed by a machine, such as a computer, a digital camera, a mobile phone, or similar, the machine becomes an apparatus for practicing the invention. The disclosed methods may also be embodied in the form of program codes transmitted over some transmission medium, such as electrical wiring or cabling, through fiber optics, or via any other form of transmission, wherein, when the program codes are received and loaded into and executed by a machine, the machine becomes an apparatus for practicing the invention. When implemented on a general-purpose processor, the program codes combine with the processor to provide a unique apparatus that operate analogously to specific logic circuits.

While the invention has been described by way of example and in terms of preferred embodiment, it is to be understood that the invention is not limited thereto. To the contrary, it is intended to cover various modifications and similar arrangements (as would be apparent to the skilled in the art). Therefore, the scope of the appended claims should be accorded to the broadest interpretation so as to encompass all such modifications and similar arrangements.

What is claimed is:

1. An apparatus for defective pixel detection and correction, comprising:
a defective pixel detection unit acquiring a detection pixel and a plurality of neighboring pixels, determining that the detection pixel is a defective pixel when a first condition and a second condition are satisfied; and
a defective pixel correction unit correcting a value of the defective pixel determined by the defective pixel detection unit,
wherein the defective pixel is located in the center of a n×n block comprising the detection and neighboring pixels, the first condition describes that at most one neighboring pixel whose value differs from the value of the detection pixel within a predefined threshold is detected, and the second condition describes that all the neighboring pixels other than the detected neighboring pixel is smaller or larger than the value of the detection pixel.

2. The apparatus of claim 1, wherein the defective pixel detection unit further determines that the detection pixel is a defective pixel when the first and second conditions, and a third condition are satisfied, wherein the third condition describes that the detection pixel is located in a smooth area.

3. The apparatus of claim 2, wherein that the detection pixel is located in a smooth area is determined by inspecting whether the detection pixel value is similar with values of the neighboring pixels.

4. The apparatus of claim 3, wherein the detection pixel is a green pixel, the defective pixel detection unit further acquires a plurality of red values of red pixels adjacent to the detection pixel, acquires a plurality of blue values of blue pixels adjacent to the detection pixel, calculates the difference between the acquired red values as a first difference value, calculates the difference between the blue values as a second difference value, and determines that the third condition is satisfied when the maximum of the calculated first and second difference values is less than a predefined threshold.

5. The apparatus of claim 3, wherein the detection pixel is a green pixel, the defective pixel detection unit further calculates a first difference value for two red values of red pixels adjacent to the detection pixel by a first formula:
Diff1=abs(R1−R2),
R1 and R2 represent the red values, and the first difference value Diff1 is an absolute value of the difference between R1 and R2, the defective pixel detection unit further calculates a second difference value for two blue values of blue pixels adjacent to the detection pixel by a second formula:
Diff2=abs(B1−B2),
B1 and B2 represent the blue values, and the second difference value Diff2 is an absolute value of the difference between B1 and B2, and the defective pixel detection unit further determines that the third condition is satisfied when the maximum of the calculated first and second difference values is less than a predefined threshold.

6. The apparatus of claim 3, wherein the detection pixel is a red pixel or a blue pixel, the defective pixel detection unit further acquires a plurality of green values of green pixels adjacent to the detection pixel, determines the minimum of the acquired green values, determines the maximum of the acquired green values, and determines that the third condition is satisfied when the maximum minus the minimum is less than a predefined threshold

7. The apparatus of claim 1, wherein the defective pixel detection unit further determines that the detection pixel is a defective pixel when the first and second conditions, and a third condition are satisfied, wherein the third condition describes that the detection pixel value is out of an acceptable range derived from neighboring pixel values of the same color as that of the detection pixel.

8. The apparatus of claim 7, wherein the detection pixel is a green color.

9. The apparatus of claim 7, wherein the neighboring pixels are grouped into a first group and a second group, the neighboring pixels of the first group have shorter distance from the detection pixel, the neighboring pixels of the second group have longer distance from the detection pixel, the defective pixel detection unit further calculates a first mean value for the neighboring pixels of the first group, calculates a second mean value for the neighboring pixels of the second group, calculates the difference between the first and second mean values, and calculates an upper bound and a lower bound of the acceptable range derived from the calculated first mean value and the calculated difference between the first and second mean values.

10. The apparatus of claim 9, wherein the first mean value is calculated by a formula:
Mean1=(G1+G2+G3+G4−min(G1,G2,G3,G4)−max(G1,G2,G3,G4))/2,
min(G1,G2,G3,G4) represents the minimum value of the neighboring pixel values of the first group, max(G1,G2,G3,G4) represents the maximum value of the neighboring pixel values of the first group, the second mean value is calculated by a formula:
Mean2=(G5+G6+G7+G8−min(G5,G6,G7,G8)−max(G5,G6,G7,G8))/2,
min(G5,G6,G7,G8) represents the minimum value of the neighboring pixel values of the second group, max(G5,G6,G7,G8) represents the maximum value of the neighboring pixel values of the second group.

11. The apparatus of claim 9, wherein the upper bound of the acceptable range is calculated by a formula:
Bound1=Mean1+Diff*T,
and the lower bound of the acceptable range is calculated by a formula:
Bound2=Mean1−Diff*T,
Mean1 represents the first mean value, Diff represents the difference between the first and second mean values, and T represents a predefined threshold.

12. The apparatus of claim 1, wherein the n×n block is a 5×5 block, and the neighboring pixels are eight pixels with the same color as the detection pixel.

13. The apparatus of claim 1, wherein the neighboring pixels are selectively acquired from the n×n block depending on the color of the detection pixel.

14. The apparatus of claim 1, wherein the n×n block is a pixel array of a Bayer pattern image.

15. A method for defective pixel detection and correction, comprising:
acquiring a detection pixel and a plurality of neighboring pixels;
determining that the detection pixel is a defective pixel when a first condition and a second condition are satisfied; and
correcting a value of the defective pixel,
wherein the defective pixel is located in the center of a n×n block comprising the detection and neighboring pixels, the first condition describes that at most one neighboring pixel whose value differs from the value of the detection pixel within a predefined threshold is detected, and the second condition describes that all the neighboring pixels other than the detected neighboring pixel is smaller or larger than the value of the detection pixel.

16. The method of claim 15, wherein the determination of the defective pixel further comprises determining the detection pixel is a defective pixel when the first and second conditions, and a third condition are satisfied, and the third condition describes that the detection pixel is located in a smooth area.

17. The method of claim 16, wherein that the detection pixel is located in a smooth area is determined by inspecting whether the detection pixel value is similar with values of the neighboring pixels.

18. The method of claim 15, wherein the determination of the defective pixel further comprises determining the detection pixel is a defective pixel when the first and second conditions, and a third condition are satisfied, and the third condition describes that the detection pixel value is out of an acceptable range derived from neighboring pixel values of the same color as that of the detection pixel.

19. The method of claim 15, wherein the neighboring pixels are selectively acquired from the n×n block depending on the color of the detection pixel.

20. The method of claim 15, wherein the n×n block is a pixel array of a Bayer pattern image.
